(19) United States
(12) Patent Application Publication
(10) Pub. No.: US 2026/0261287 A1
(43) Pub. Date: Sep. 3, 2026

(54) Communication Session for Supporting a User Equipment by a Reconfigurable Intelligent Surface

(71) Applicant: Telefonaktiebolaget LM Ericsson (publ), Stockholm (SE)

(72) Inventors: Rickard Ljung, Helsingborg (SE); Henrik Sjöland, Lund (SE); Mojtaba Mahdavi, Lund (SE); Shousheng He, Södra Sandby (SE); Magnus Olsson, Klagshamn (SE)

(21) Appl. No.: 19/163,417

(22) PCT Filed: Mar. 9, 2023
(86) PCT No.: PCT/EP2023/056053

§ 371 Date: Sep. 9, 2025

(51) Int. Cl. H04B 7/04

(52) U.S. Cl. CPC H04B 7/04013

(57) ABSTRACT

There is provided techniques for maintaining a communication session between a UE and a controller entity of an RIS. The controller entity receives a request signal from the UE to activate the RIS for wireless signals as transmitted and/or received by the UE to be reflected by the RIS. The controller entity controls beam reflection properties of the RIS to reflect the wireless signals as transmitted and/or received by the UE. The controller entity sends a response signal towards the UE that the RIS has been activated. The controller entity continues controlling the reflection properties of the RIS to reflect beams of the wireless signals as transmitted and/or received by the UE whilst signalling indicative of that the communication session is to be maintained is repeatedly received from the UE.

### TECHNICAL FIELD

Embodiments presented herein relate to methods, a controller entity of a reconfigurable intelligent surface, a user equipment, computer programs, and a computer program product for maintaining a communication session between the controller entity and the user equipment.

### BACKGROUND

A reconfigurable intelligent surface (RIS) offers an opportunity for improved wireless communication. Specifically, significant gains are envisioned to be made for millimetre wave spectrum, which is used in fifth generation and sixth generation telecommunication systems. This spectrum has serious challenges when it comes to propagation and coverage, e.g., due to its very high frequency ranges in tens of GHz. The challenges are larger compared to challenges for spectrum with lower frequencies e.g., for so-called sub-6 GHz frequency bands.

RISs represent an emerging technology that is capable of intelligently manipulating the propagation of electro-magnetic waves. A RIS is commonly also referred to as a large intelligent surface, a smart reflect-array, an intelligent reflecting surface, a passive intelligent mirror, an artificial radio space, and a meta-surface.

In general terms, a RIS is composed of a 2-dimensional array of reflecting antenna elements, such as patch antennas, where each antenna element acts as a passive reconfigurable scatterer, i.e., a piece of manufactured material, which can be configured to change (the beam of) an impinging electro-magnetic wave in a customizable way. Such antenna elements are commonly provided as low-cost passive surfaces that do not require dedicated power sources, and the radio waves impinged upon them can be forwarded without the need of employing power amplifier or radio chain. Moreover, a RIS can, potentially, operate in full duplex mode without significant self-interference or increased noise level and requires only low-rate control link or backhaul connections. A RIS can be flexibly deployed due to its low weight and low power consumption

It is hereinafter assumed that the activation and deactivation of the RIS is requested by user equipment (UEs), meaning the network nodes (such as base stations) in the network do not require to control the RIS.

R. Liu, G. C. Alexandropoulos, Q. Wu, M. Jian and Y. Liu, in “How Can Reconfigurable Intelligent Surfaces Drive 5G-Advanced Wireless Networks: A Standardization Perspective,” 2022 IEEE/CIC International Conference on Communications in China (ICCC Workshops), Sanshui, Foshan, China, 2022, pp. 221-226, doi: 10.1109/ICCCWorkshops55477.2022.9896658, provides an overview of RIS usage and potential benefits such as cost efficiency, power consumption etc. Use cases such as network controlled RIS and UE controlled RIS (for device-to-device configurations) are outlined. Further, for a UE controlled RIS it mentions that the RIS needs to be controlled and that the control information can come from a UE.

In other words, a UE will need to send some kind of request signal to the RIS for the RIS to start supporting the UE by reflecting beams of wireless signals as transmitted and/or received by the UE.

Still further, even if the RIS responds to the UE, the UE does not know for how long the RIS will provide support for the UE. Likewise, the RIS does not know for how long the support for the UE is needed.

### SUMMARY

An object of embodiments herein is to address the above issues.

A particular object is to ensure coordination between the RIS and the UE so that the UE knows for how long the RIS will provide support for the UE and so that the RIS knows for how long the support for the UE is needed.

A particular object is to establish a control channel between the RIS and the UE, where this control channel is maintained as long as the UE is supported by the RIS.

According to a first aspect there is presented a controller entity of an RIS for maintaining a communication session between a UE and the controller entity. The controller entity comprises processing circuitry. The processing circuitry is configured to cause the controller entity to receive a request signal from the UE to activate the RIS for wireless signals as transmitted and/or received by the UE to be reflected by the RIS. The processing circuitry is configured to cause the controller entity to control beam reflection properties of the RIS to reflect the wireless signals as transmitted and/or received by the UE. The processing circuitry is configured to cause the controller entity to send a response signal towards the UE that the RIS has been activated. The response signal is indicative of that the communication session has been established between the UE and the controller entity. The processing circuitry is configured to cause the controller entity to continue to control the reflection properties of the RIS to reflect beams of the wireless signals as transmitted and/or received by the UE whilst signalling indicative of that the communication session is to be maintained is repeatedly received from the UE.

According to a second aspect there is presented a controller entity of an RIS for maintaining a communication session between a UE and the controller entity. The controller entity comprises a receive module configured to receive a request signal from the UE to activate the RIS for wireless signals as transmitted and/or received by the UE to be reflected by the RIS. The controller entity comprises a control module configured to control beam reflection properties of the RIS to reflect the wireless signals as transmitted and/or received by the UE. The controller entity comprises a send module configured to send a response signal towards the UE that the RIS has been activated. The response signal is indicative of that the communication session has been established between the UE and the controller entity. The controller entity comprises a control module configured to continue to control the reflection properties of the RIS to reflect beams of the wireless signals as transmitted and/or received by the UE whilst signalling indicative of that the communication session is to be maintained is repeatedly received from the UE.

According to a third aspect there is presented a method for maintaining a communication session between a UE and a controller entity of an RIS. The method is performed by the controller entity. The method comprises receiving a request signal from the UE to activate the RIS for wireless signals as transmitted and/or received by the UE to be reflected by the RIS. The method comprises controlling beam reflection properties of the RIS to reflect the wireless signals as transmitted and/or received by the UE. The method comprises sending a response signal towards the UE that the RIS has been activated. The response signal is indicative of that the communication session has been established between the UE and the controller entity. The method comprises continuing controlling the reflection properties of the RIS to reflect beams of the wireless signals as transmitted and/or received by the UE whilst signalling indicative of that the communication session is to be maintained is repeatedly received from the UE.

According to a fourth aspect there is presented a computer program for maintaining a communication session between a UE and the controller entity of an RIS. The computer program comprises computer code which, when run on processing circuitry of the controller entity, causes the controller entity to perform actions. One action comprises the controller entity to receive a request signal from the UE to activate the RIS for wireless signals as transmitted and/or received by the UE to be reflected by the RIS. One action comprises the controller entity to control beam reflection properties of the RIS to reflect the wireless signals as transmitted and/or received by the UE. One action comprises the controller entity to send a response signal towards the UE that the RIS has been activated. The response signal is indicative of that the communication session has been established between the UE and the controller entity. One action comprises the controller entity to continue to control the reflection properties of the RIS to reflect beams of the wireless signals as transmitted and/or received by the UE whilst signalling indicative of that the communication session is to be maintained is repeatedly received from the UE.

According to a fifth aspect there is presented a UE for maintaining a communication session between the UE and a controller entity of an RIS. The UE comprises processing circuitry. The processing circuitry is configured to cause the UE to send a request signal towards the controller entity to activate the RIS for wireless signals as transmitted and/or received by the UE to be reflected by the RIS. The processing circuitry is configured to cause the UE to receive a response signal from the controller entity that the RIS has been activated for reflection of the wireless signals. The response signal is indicative of that the communication session has been established between the UE and the controller entity. The processing circuitry is configured to cause the UE to repeatedly provide signalling towards the controller entity indicative of that the communication session is to be maintained whilst performing a multipath wireless communication comprises transmitting and/or receiving the wireless signals.

According to a sixth aspect there is presented a UE for maintaining a communication session between the UE and a controller entity of an RIS. The UE comprises a send module configured to send a request signal towards the controller entity to activate the RIS for wireless signals as transmitted and/or received by the UE to be reflected by the RIS. The UE comprises a receive module configured to receive a response signal from the controller entity that the RIS has been activated for reflection of the wireless signals. The response signal is indicative of that the communication session has been established between the UE and the controller entity. The UE comprises a provide module configured to repeatedly provide signalling towards the controller entity indicative of that the communication session is to be maintained whilst performing a multipath wireless communication comprises transmitting and/or receiving the wireless signals.

According to a seventh aspect there is presented a method for maintaining a communication session between a UE and a controller entity of an RIS. The method is performed by the UE. The method comprises sending a request signal towards the controller entity to activate the RIS for wireless signals as transmitted and/or received by the UE to be reflected by the RIS. The method comprises receiving a response signal from the controller entity that the RIS has been activated for reflection of the wireless signals. The response signal is indicative of that the communication session has been established between the UE and the controller entity. The method comprises repeatedly providing signalling towards the controller entity indicative of that the communication session is to be maintained whilst performing a multipath wireless communication comprises transmitting and/or receiving the wireless signals.

According to an eighth aspect there is presented a computer program for maintaining a communication session between a UE and a controller entity of an RIS. The computer program comprises computer code which, when run on processing circuitry of a UE, causes the UE to perform actions. One action comprises the UE to send a request signal towards the controller entity to activate the RIS for wireless signals as transmitted and/or received by the UE to be reflected by the RIS. One action comprises the UE to receive a response signal from the controller entity that the RIS has been activated for reflection of the wireless signals. The response signal is indicative of that the communication session has been established between the UE and the controller entity. One action comprises the UE to repeatedly provide signalling towards the controller entity indicative of that the communication session is to be maintained whilst performing a multipath wireless communication comprises transmitting and/or receiving the wireless signals.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects resolve the above issues.

Advantageously, these aspects ensure coordination between the controller entity and the UE so that the UE knows for how long the RIS will provide support for the UE and so that the controller entity knows for how long the support for the UE is needed.

Advantageously, these aspects enable a control channel between the controller entity and the UE to be established and maintained as long as the UE is supported by the RIS.

Advantageously, these aspects enable the controller entity and the UE to, over time, be aware of whether the RIS is supporting the UE or not.

Advantageously, these aspects enable the controller entity and the UE to be aware of what control signaling is required to enable the RIS to support the UE.

Advantageously, in this way a session is defined for the RIS support

Advantageously, these aspects enable the session to be maintained in a low complexity manner requiring only a very limited amount of control signaling messages to be passed between the controller entity and the UE for establishing and maintaining the session.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a schematic diagram illustrating an RIS according to embodiments;

FIGS. 3 and 4 are flowcharts of methods according to embodiments;

FIG. 5 is a signalling diagram of a method according to an embodiment;

FIG. 6 is a schematic diagram showing functional units of a controller entity according to an embodiment;

FIG. 7 is a schematic diagram showing functional modules of a controller entity according to an embodiment;

FIG. 8 is a schematic diagram showing functional units of a UE according to an embodiment;

FIG. 9 is a schematic diagram showing functional modules of a UE according to an embodiment; and

FIG. 10 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

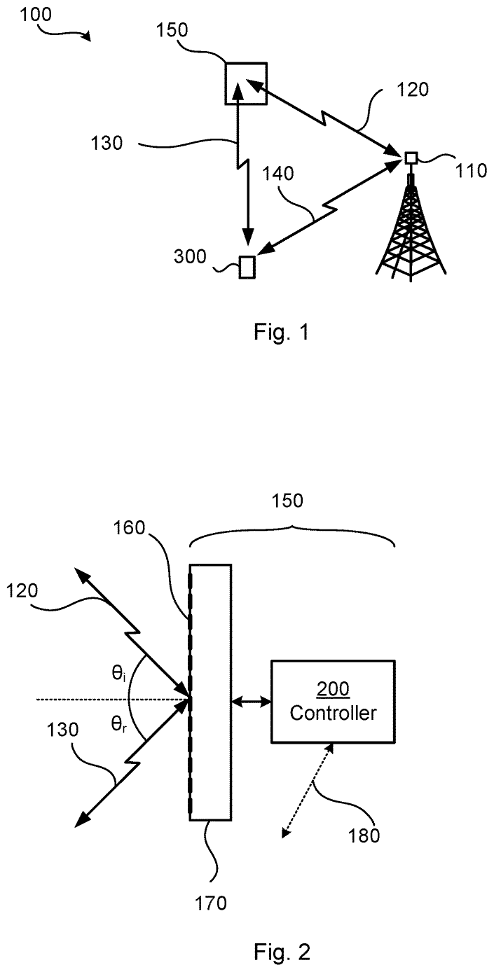

FIG. 1 is a schematic diagram illustrating a communication network 100 where a RIS 150 is shown as assisting communication between a network node 110 and a UE 300 over wireless links 120, 130, 140. In this respect, the UE 300 and the network node 110 communicate over a direct link, as represented by wireless link 140, and an indirect link via the RIS 150, as represented by wireless links 120, 130. In some examples the network node 110 is a transceiver point, an access point, an integrated access and backhaul node, a base station, a repeater, a gNB, or the like.

FIG. 2 is a schematic illustration of an example RIS 150. The RIS 150 comprises a controller entity 200 and a reflector entity 170, comprising a meta-surface or other type of array structure with reflecting antenna elements 160. The controller entity 200 is configured to control the reflection angle of the reflector entity 170 for reflecting radio waves over the indirect wireless link 120, 130 between the network node 110 and the UE 300. The controller entity 200 further is provided with transceiver circuitry for communicating with the UE 300 over a control channel (as indicated by the wireless link 180 regarding whether or not the RIS 150 should assist the UE 300 for communication with the network node 110. In further detail, by the controller entity 200 controlling the impedances of the respective reflecting antenna elements 160, the reflection angle Or of an incoming radio wave, or beam, having an angle of incidence θi, can be adapted according to the generalized Snell's law. FIG. 2 only illustrates one example implementation of the RIS 150 and the implementation might differ dependent on the type of RIS 150. Usage of the RIS 150 can vary, but in general the RIS can be configured to reflect wireless signals in a controlled manner, e.g., to steer transmitted signals in a certain direction. This could for example be used to improve overall system coverage, range, and efficiency.

As noted above, a UE 300 will need to send some kind of request signal to the RIS 150 (or actually, the controller entity 200) for the RIS 150 to start supporting the UE 300 by reflecting beams of wireless signals as transmitted and/or received by the UE 300 (in the direction towards the network node 110).

As further noted above, even if the RIS 150 (or actually, the controller entity 200) responds to the UE 300, the UE 300 does not know for how long the RIS 150 will provide support for the UE 300. Likewise, the RIS 150 (or actually, the controller entity 200) does not know for how long the support for the UE 300 is needed.

One way to address this issue is to provide coordination between the controller entity 200 and the UE 300 so that the UE 300 knows for how long the RIS 150 will provide support for the UE 300 and so that the controller entity 200 knows for how long the support for the UE 300 is needed.

A further way to address this issue is to enable a control channel to be established between the controller entity 200 and the UE 300, where this control channel is maintained as long as the UE 300 is supported by the RIS 150.

The embodiments disclosed herein therefore relate to techniques for maintaining a communication session between the UE 300 and the controller entity 200. In order to obtain such techniques, there is provided a controller entity 200, a method performed by the controller entity 200, a computer program product comprising code, for example in the form of a computer program, that when run on processing circuitry of the controller entity 200, causes the controller entity 200 to perform the method. In order to obtain such techniques, there is further provided a UE 300, a method performed by the UE 300, and a computer program product comprising code, for example in the form of a computer program, that when run on processing circuitry of the UE 300, causes the UE 300 to perform the method.

In general terms, once the controller entity 200 has determined that the RIS 150 is to support a UE 300, a communication session is established to support the interaction between the controller entity 200 and the UE 300. By means of such a communication session the controller entity 200 can be kept up to date with whether the UE 300 continues to have a need to be supported by the RIS 150 and for the controller entity 200 to be enabled to adaptively configure the RIS 150 over time in a changing radio environment (due to channel fading and mobility). The herein disclosed embodiments enable such a communication session to be established and maintained between the controller entity 200 and the UE 300.

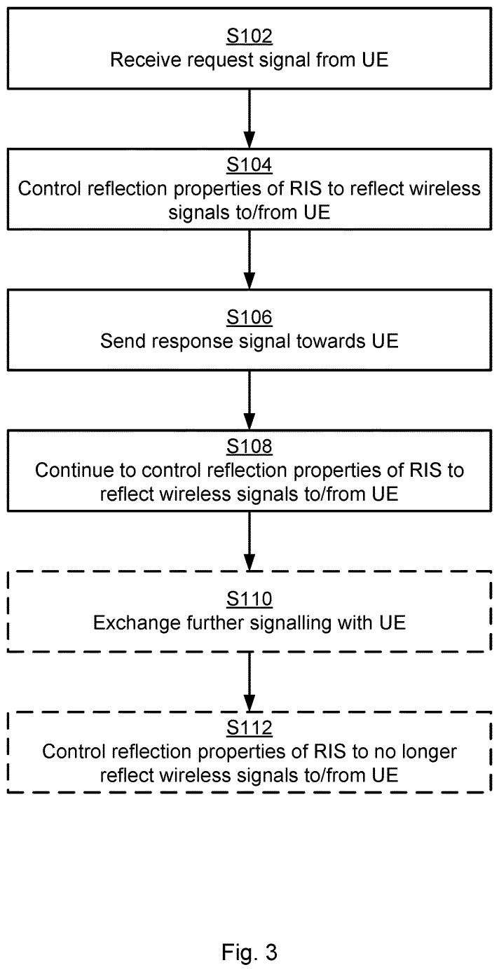

Reference is now made to FIG. 3 illustrating a method for maintaining a communication session between a UE 300 and a controller entity 200 of an RIS 150 as performed by the controller entity 200 according to an embodiment.

S102: The controller entity 200 receives a request signal from the UE 300 to activate the RIS 150 for wireless signals as transmitted and/or received by the UE 300 to be reflected by the RIS 150.

In general terms, the wireless signals as transmitted and/or received by the UE 300 are to be reflected in a direction towards the network node 110.

The controller entity 200 checks if it is possible for the RIS 150 to support the UE 300, and if so, configures the RIS 150 accordingly. This configuration is achieved by controlling beam reflection properties of the RIS 150.

S104: The controller entity 200 controls beam reflection properties of the RIS 150 to reflect the wireless signals as transmitted and/or received by the UE 300.

In general terms, the beam reflection properties of the RIS 150 are controlled such that the wireless signals as transmitted and/or received by the UE 300 are to be reflected in a direction towards the network node 110.

In general terms, controlling beam reflection properties of the RIS 150 implies that the RIS 150 is activated for reflection. An activation for reflection may in some examples be performed by adjusting one or more antenna elements of the RIS 150 for the RIS 150 to reflect signals transmitted by the network node 110 in a direction towards the UE 300, or via further reflections on objects that enhances the communication path for the UE 300. An activation for reflection may in some examples be performed by adjusting one or more antenna elements of the RIS 150 for the RIS150 to reflect signals transmitted by the UE 300 in a direction towards a network node 110 with which the UE 300 is communicating. The activation may also be denoted as a support to the UE 300 by the RIS 150 or a configuration of a RIS 150 to support the UE 300.

Examples of how the the beam reflection properties might be determined in S104 will be provided below.

In general terms, the communication session is initiated when the controller entity 200 confirms to the UE 300 that this UE 300 is to be supported by the RIS 150.

S106: The controller entity 200 sends a response signal towards the UE 300 that the RIS 150 has been activated. The response signal is indicative of that the communication session has been established between the UE 300 and the controller entity 200.

Using the request signal from the UE as a starting point of the procedure, the controller entity 200 responds to the UE 300 with a response signal. With the transmission of the response signal, the communication session is considered as initiated.

S108: The controller entity 200 continues controlling the reflection properties of the RIS 150 to reflect beams of the wireless signals as transmitted and/or received by the UE 300. The reflection properties of the RIS 150 are continuously controlled whilst signalling indicative of that the communication session is to be maintained is repeatedly received by the controller entity 200 from the UE 300.

Examples of how the controller entity 200 might keep controlling the reflection properties of the RIS 150 to reflect beams of the wireless signals as transmitted and/or received by the UE 300 will be disclosed below.

Advantageously, this method resolves the above issues.

Advantageously, this method ensures coordination between the controller entity and the UE so that the UE knows for how long the RIS will provide support for the UE and so that the controller entity knows for how long the support for the UE is needed.

Advantageously, this method enables a control channel between the controller entity and the UE to be established and maintained as long as the UE is supported by the RIS.

Advantageously, this method enables the controller entity and the UE to, over time, be aware of whether the RIS is supporting the UE or not.

Advantageously, this method enables the controller entity and the UE to be aware of what control signaling is required to enable the RIS to support the UE.

Advantageously, in this way a session is defined for the RIS support

Advantageously, this method enables the session to be maintained in a low complexity manner requiring only a very limited amount of control signaling messages to be passed between the controller entity and the UE for establishing and maintaining the session.

Embodiments relating to further details of maintaining the communication session between the UE 300 and the controller entity 200 as performed by the controller entity 200 will now be disclosed with continued reference to FIG. 3.

During the ongoing communication session, the UE 300 might repeatedly transmit signalling indicative of that the communication session is to be maintained. That is, in some embodiments, the signalling indicative of that the communication session is to be maintained is repeatedly received from the UE 300 as long as the communication session is to be maintained.

There could be different types of signalling that is received by the controller entity 200 in S108. In some embodiments, the signalling indicative of that the communication session is to be maintained either is identical to the request signal or is a tracking signal. In some aspects, the actual content of the request signal and the tracking signal is the same, but the signals are interpreted differently by the controller entity 200 (depending on if the signal is received before or after the RIS 150 has been activated to support the UE 300.

There could be different ways in which the communication session is terminated. For example, the communication session might be terminated when a session timer expires or when explicit signaling is exchanged between the controller entity 200 and the UE 300.

In this respect, a session timer, as started when the communication session is initiated, could define a maximum session length as determined by the controller entity 200. The communication session may then be released, or terminated, when the session timer expires. Therefore, in some embodiments, the response signal comprises information of a session timer. The communication session at most is to be maintained until the session timer expires.

Additionally and/or alternatively, the communication session might be ended via explicit signaling between the controller entity 200 and the UE 300. This signaling can be initiated either from the controller entity 200 or from the UE 300. An example of the former is when the UE 300 has no more data to send and/or receive. An example of the latter is when the RIS 150 is to support higher prioritized UE. In particular, in some embodiments the controller entity 200 is configured to perform (optional) steps S110 and S112.

S110: The controller entity 200 exchanges further signalling with the UE 300 to terminate the communication session.

S112: The controller entity 200 controls the reflection properties of the RIS 150 to no longer reflect the wireless signals as transmitted and/or received by the UE 300 upon having exchanged the further signalling.

Yet alternatively, the communication session might be ended when the UE 300 stops sending the signalling that is received by the controller entity 200 in S108.

In general terms, beam reflection properties of the RIS 150 can be determined based on the angle of arrival of signals received by the controller entity 200 from the UE 300. In particular, in some embodiments, the beam reflection properties of the RIS 150 initially are determined based on angle of arrival of the request signal.

Likewise, the reflection properties of RIS 150 can be adaptively updated over time based on the angle of arrival of further signals received by the controller entity 200 from the UE 300. In particular, in some embodiments, the beam reflection properties of the RIS 150 are adaptively updated over time based on angle of arrival of the signalling as repeatedly received from the UE 300. The controller entity 200 can thereby use the signalling as received from the UE in S108 to keep track of the direction towards the UE 300 relative the RIS 150.

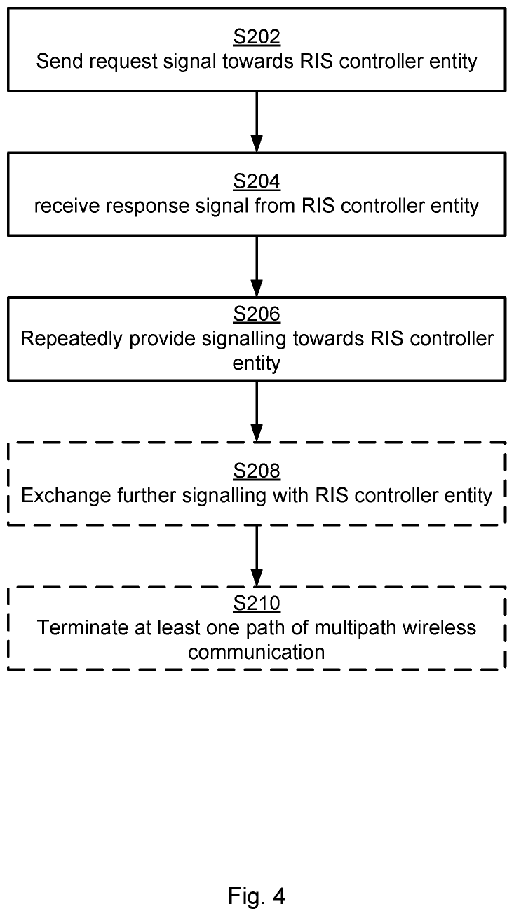

Reference is now made to FIG. 4 illustrating a method for maintaining a communication session between a UE 300 and a controller entity 200 of an RIS 150 as performed by the UE 300 according to an embodiment.

S202: The UE 300 sends a request signal towards the controller entity 200 to activate the RIS 150 for wireless signals as transmitted and/or received by the UE 300 to be reflected by the RIS 150.

As above, in general terms, the wireless signals as transmitted and/or received by the UE 300 are to be reflected by the RIS 150 in a direction towards the network node 110.

S204: The UE 300 receives a response signal from the controller entity 200 that the RIS 150 has been activated for reflection of the wireless signals. The response signal is indicative of that the communication session has been established between the UE 300 and the controller entity 200.

The response signal indicates to the UE 300 that the communication session has been initiated.

S206: The UE 300 repeatedly provides signalling towards the controller entity 200 indicative of that the communication session is to be maintained. The signalling is repeatedly provided towards the controller entity 200 whilst the UE 300 is performing a multipath wireless communication comprising transmitting and/or receiving the wireless signals.

In general terms, the multipath wireless communication is performed between the UE 300 and the network node 110.

Embodiments relating to further details of maintaining the communication session between the UE 300 and the controller entity 200 as performed by the UE 300 will now be disclosed with continued reference to FIG. 4.

As disclosed above, during the ongoing communication session, the UE 300 might repeatedly transmit signalling indicative of that the communication session is to be maintained. That is, in some embodiments, the signalling is repeatedly provided towards the controller entity 200 as long as the multipath wireless communication is ongoing.

There could be different types of signalling that is provided by the UE 300 towards the controller entity 200 in S206. As disclosed above, in some embodiments, the signalling indicative of that the communication session is to be maintained either is identical to the request signal or is a tracking signal. That is, the UE 300 might either repeatedly send a request signal, or repeatedly send a tracking signal, where the latter then only is sent upon the UE 300 having received the response signal in S204. In some aspects, the content of the request signal and the content of the tracking signal is the same. However, in other aspects, the tracking signal comprises only the minimum required information for the communication session to be maintained. Hence, compared to the request signal the tracking signal might include less information fields, e.g., only information indicative of the UE identity.

As disclosed above, there could be different ways in which the communication session is terminated. For example, the communication session might be terminated when a session timer expires or when explicit signaling is exchanged between the controller entity 200 and the UE 300.

As disclosed above, in some embodiments, the response signal comprises information of a session timer. The communication session at most is to be maintained until the session timer expires.

As further disclosed above, additionally and/or alternatively, the communication session might be ended via explicit signaling between the controller entity 200 and the UE 300. In particular, in some embodiments the controller entity 200 is configured to perform (optional) steps S208 and S210.

S208: The UE 300 exchanges further signalling with the controller entity 200 to terminate the communication session.

S210: The UE 300 terminates at least a first path of the multipath wireless communication upon having exchanged the further signalling.

In this respect, performing the multipath wireless communication might comprise the UE 300 to direct the at least first path (utilizing wireless links 120, 130) of the multipath wireless communication for transmission and/or reception of the wireless signals to be reflected by the RIS 150 and to direct at least a second path (utilizing wireless link 140) of the multipath wireless communication for transmission and/or reception of the wireless signals to not be reflected by the RIS 150.

As further disclosed above, yet alternatively, the communication session might be ended when the UE 300 stops sending the signalling in S206.

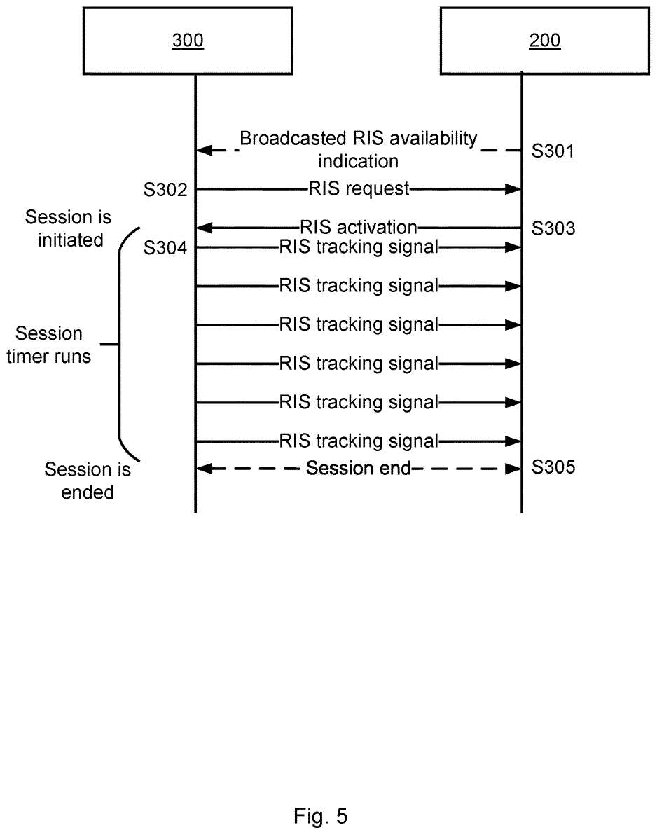

One particular embodiment for maintaining a communication session between a UE 300 and a controller entity 200 of an RIS 150 based on at least some of the above disclosed embodiments will now be disclosed in detail with reference to the signalling diagram of FIG. 5.

S301 (optional): The controller entity 200 broadcasts information that the RIS 150 is available to support one or more UEs 300.

S302: The UE 300 sends a request signal towards the controller entity 200 to activate the RIS 150 for wireless signals as transmitted and/or received by the UE 300 to be reflected by the RIS 150. In general terms, the wireless signals as transmitted and/or received by the UE 300 are to be reflected by the RIS 150 in a direction towards the network node 110.

S303: The controller entity 200 controls beam reflection properties of the RIS 150 to reflect the wireless signals as transmitted and/or received by the UE 300. In general terms, the beam reflection properties of the RIS 150 are controlled such that the wireless signals as transmitted and/or received by the UE 300 are to be reflected in a direction towards the network node 110. Further, the controller entity 200 sends a response signal towards the UE 300 that the RIS 150 has been activated. The response signal is indicative of that the communication session has been established between the UE 300 and the controller entity 200.

S304: The UE 300 repeatedly provides signalling towards the controller entity 200 indicative of that the communication session is to be maintained. The signalling is repeatedly provided towards the controller entity 200 whilst the UE 300 is performing a multipath wireless communication comprising transmitting and/or receiving the wireless signals. The controller entity 200 continues controlling the reflection properties of the RIS 150 to reflect beams of the wireless signals as transmitted and/or received by the UE 300 (in the direction towards the network node 110) whilst the signalling indicative of that the communication session is to be maintained is repeatedly received from the UE 300.

S305 (optional): The UE 300 and the controller entity 200 exchange further signalling to terminate the communication session.

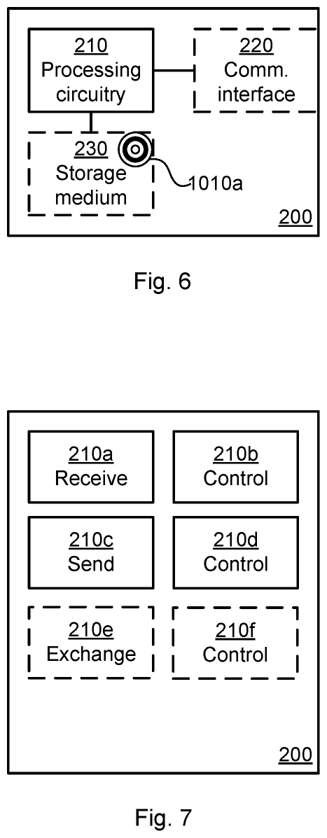

FIG. 6 schematically illustrates, in terms of a number of functional units, the components of a controller entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1010a (as in FIG. 10), e.g. in the form of a storage medium 230. The processing circuitry 210 may further be provided as at least one application specific integrated circuit (ASIC), or field programmable gate array (FPGA).

Particularly, the processing circuitry 210 is configured to cause the controller entity 200 to perform a set of operations, or steps, as disclosed above. For example, the storage medium 230 may store the set of operations, and the processing circuitry 210 may be configured to retrieve the set of operations from the storage medium 230 to cause the controller entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The controller entity 200 may further comprise a communications (comm.) interface 220 for communications with other entities, functions, nodes, and devices, as in FIGS. 1 and 2. As such the communications interface 220 may comprise one or more transmitters and receivers, comprising analogue and digital components.

The processing circuitry 210 controls the general operation of the controller entity 200 e.g. by sending data and control signals to the communications interface 220 and the storage medium 230, by receiving data and reports from the communications interface 220, and by retrieving data and instructions from the storage medium 230. Other components, as well as the related functionality, of the controller entity 200 are omitted in order not to obscure the concepts presented herein.

FIG. 7 schematically illustrates, in terms of a number of functional modules, the components of a controller entity 200 according to an embodiment. The controller entity 200 of FIG. 7 comprises a number of functional modules; a receive module 210a configured to perform step S102, a (first) control module 210b configured to perform step S104, a send module 210c configured to perform step S106, and a (second) control module 210d configured to perform step S108. The controller entity 200 of FIG. 7 may further comprise a number of optional functional modules, such as any of an exchange module 210e configured to perform step S110, and a (third) control module 210f configured to perform step S112. In general terms, each functional module 210a:210f may be implemented in hardware or in software. Preferably, one or more or all functional modules 210a:210f may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210f and to execute these instructions, thereby performing any steps of the controller entity 200 as disclosed herein.

The controller entity 200 may be provided as a standalone device or as a part of at least one further device. Thus, a first portion of the instructions performed by the controller entity 200 may be executed in a first device, and a second portion of the instructions performed by the controller entity 200 may be executed in a second device; the herein disclosed embodiments are not limited to any particular number of devices on which the instructions performed by the controller entity 200 may be executed. Hence, the methods according to the herein disclosed embodiments are suitable to be performed by a controller entity 200 residing in a cloud computational environment. Therefore, although a single processing circuitry 210 is illustrated in FIG. 6 the processing circuitry 210 may be distributed among a plurality of devices, or nodes. The same applies to the functional modules 210a:210f of FIG. 7 and the computer program 1020a of FIG. 10.

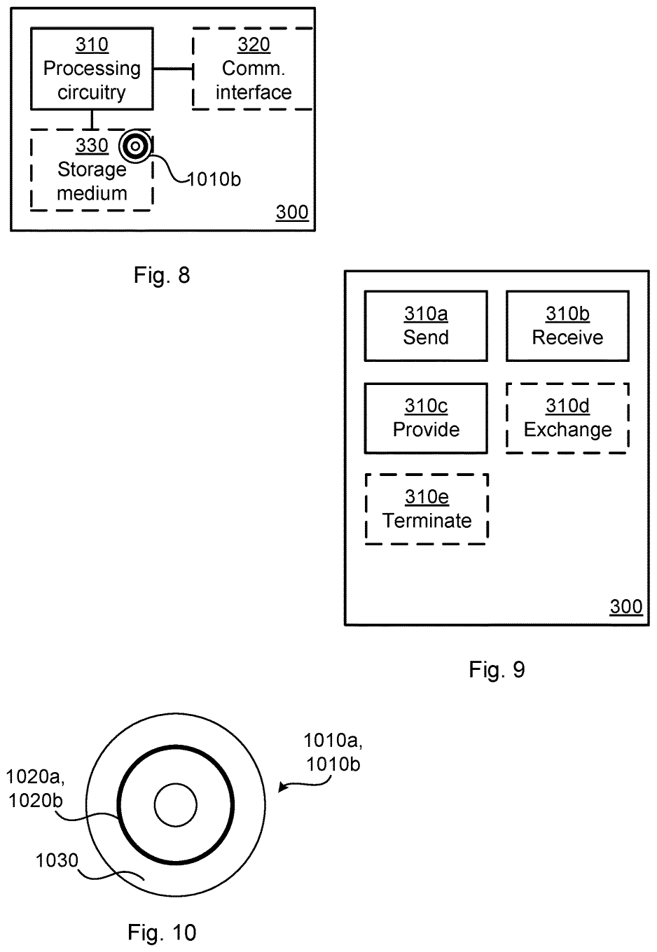

FIG. 8 schematically illustrates, in terms of a number of functional units, the components of a UE 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1010b (as in FIG. 10), e.g. in the form of a storage medium 330. The processing circuitry 310 may further be provided as at least one application specific integrated circuit (ASIC), or field programmable gate array (FPGA).

Particularly, the processing circuitry 310 is configured to cause the UE 300 to perform a set of operations, or steps, as disclosed above. For example, the storage medium 330 may store the set of operations, and the processing circuitry 310 may be configured to retrieve the set of operations from the storage medium 330 to cause the UE 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The UE 300 may further comprise a communications interface 320 for communications with other entities, functions, nodes, and devices, as in FIG. 1. As such the communications interface 320 may comprise one or more transmitters and receivers, comprising analogue and digital components.

The processing circuitry 310 controls the general operation of the UE 300 e.g. by sending data and control signals to the communications interface 320 and the storage medium 330, by receiving data and reports from the communications interface 320, and by retrieving data and instructions from the storage medium 330. Other components, as well as the related functionality, of the UE 300 are omitted in order not to obscure the concepts presented herein.

FIG. 9 schematically illustrates, in terms of a number of functional modules, the components of a UE 300 according to an embodiment. The UE 300 of FIG. 9 comprises a number of functional modules; a send module 310a configured to perform step S202, a receive module 210b configured to perform step S204, and a provide module 310c configured to perform step S206. The UE 300 of FIG. 9 may further comprise a number of optional functional modules, such as any of an exchange module 310d configured to perform step S208, and a terminate module 310e configured to perform step S210. In general terms, each functional module 310a:310e may be implemented in hardware or in software. Preferably, one or more or all functional modules 310a:310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310e and to execute these instructions, thereby performing any steps of the UE 300 as disclosed herein.

FIG. 10 shows one example of a computer program product 1010a, 1010b comprising computer readable means 1030. On this computer readable means 1030, a computer program 1020a can be stored, which computer program 1020a can cause the processing circuitry 210 and thereto operatively coupled entities and devices, such as the communications interface 220 and the storage medium 230, to execute methods according to embodiments described herein. The computer program 1020a and/or computer program product 1010a may thus provide means for performing any steps of the controller entity 200 as herein disclosed. On this computer readable means 1030, a computer program 1020b can be stored, which computer program 1020b can cause the processing circuitry 310 and thereto operatively coupled entities and devices, such as the communications interface 320 and the storage medium 330, to execute methods according to embodiments described herein. The computer program 1020b and/or computer program product 1010b may thus provide means for performing any steps of the UE 300 as herein disclosed.

In the example of FIG. 10, the computer program product 1010a, 1010b is illustrated as an optical disc, such as a CD (compact disc) or a DVD (digital versatile disc) or a Blu-Ray disc. The computer program product 1010a, 1010b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020a, 1020b is here schematically shown as a track on the depicted optical disk, the computer program 1020a, 1020b can be stored in any way which is suitable for the computer program product 1010a, 1010b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-19. (canceled)

20. A controller entity of a reconfigurable intelligent surface (RIS) for maintaining a communication session between a user equipment (UE) and the controller entity, the controller entity comprising processing circuitry, the processing circuitry being configured to cause the controller entity to:
receive a request signal from the UE to activate the RIS for wireless signals as transmitted and/or received by the UE to be reflected by the RIS;
control beam reflection properties of the RIS to reflect the wireless signals as transmitted and/or received by the UE;
send a response signal towards the UE that the RIS has been activated, wherein the response signal is indicative of that the communication session has been established between the UE and the controller entity; and
continue to control the reflection properties of the RIS to reflect beams of the wireless signals as transmitted and/or received by the UE whilst signalling indicative of that the communication session is to be maintained is repeatedly received from the UE.

21. The controller entity of claim 20, wherein the signalling indicative of that the communication session is to be maintained is repeatedly received from the UE as long as the communication session is to be maintained.

22. The controller entity of claim 20, wherein the signalling indicative of that the communication session is to be maintained either is identical to the request signal or is a tracking signal.

23. The controller entity of claim 20, wherein the response signal comprises information of a session timer, and wherein the communication session at most is to be maintained until the session timer expires.

24. The controller entity of claim 20, the processing circuitry further being configured to cause the controller entity to:
exchange further signalling with the UE to terminate the communication session; and
control the reflection properties of the RIS to no longer reflect the wireless signals as transmitted and/or received by the UE upon having exchanged the further signalling.

25. The controller entity of claim 20, wherein the beam reflection properties of the RIS initially are determined based on angle of arrival of the request signal.

26. The controller entity of claim 20, wherein the beam reflection properties of the RIS are adaptively updated over time based on angle of arrival of the signalling as repeatedly received from the UE.

27. A user equipment (UE) for maintaining a communication session between the UE and a controller entity of a reconfigurable intelligent surface (RIS) the UE comprising processing circuitry, the processing circuitry being configured to cause the UE to:
send a request signal towards the controller entity to activate the RIS for wireless signals as transmitted and/or received by the UE to be reflected by the RIS;
receive a response signal from the controller entity that the RIS has been activated for reflection of the wireless signals, wherein the response signal is indicative of that the communication session has been established between the UE and the controller entity; and
repeatedly provide signalling towards the controller entity indicative of that the communication session is to be maintained whilst performing a multipath wireless communication comprising transmitting and/or receiving the wireless signals.

28. The UE of claim 27, wherein the signalling is repeatedly provided towards the controller entity as long as the multipath wireless communication is ongoing.

29. The UE of claim 27, wherein the signalling either is identical to the request signal or is a tracking signal.

30. The UE of claim 27, wherein the response signal comprises information of a session timer, and wherein the communication session at most is to be maintained until the session timer expires.

31. The UE of claim 27, wherein performing the multipath wireless communication comprises directing at least a first path of the multipath wireless communication for transmission and/or reception of the wireless signals to be reflected by the RIS and directing at least a second path of the multipath wireless communication for transmission and/or reception of the wireless signals to not be reflected by the RIS, the processing circuitry further being configured to cause the UE to:
exchange further signalling with the controller entity to terminate the communication session; and
terminate at least the first path of the multipath wireless communication upon having exchanged the further signalling.

32. A method for maintaining a communication session between a user equipment (UE) and a controller entity of a reconfigurable intelligent surface (RIS), wherein the method is performed by the controller entity and wherein the method comprises:
receiving a request signal from the UE to activate the RIS for wireless signals as transmitted and/or received by the UE to be reflected by the RIS;
controlling beam reflection properties of the RIS to reflect the wireless signals as transmitted and/or received by the UE;
sending a response signal towards the UE that the RIS has been activated, wherein the response signal is indicative of that the communication session has been established between the UE and the controller entity; and
continuing controlling the reflection properties of the RIS to reflect beams of the wireless signals as transmitted and/or received by the UE whilst signalling indicative of that the communication session is to be maintained is repeatedly received from the UE.

33. The method of claim 32, wherein the signalling indicative of that the communication session is to be maintained is repeatedly received from the UE as long as the communication session is maintained.

34. The method of claim 32, wherein the signalling indicative of that the communication session is to be maintained either is identical to the request signal or is a tracking signal.

35. The method of claim 32, the method further comprising:
exchanging further signalling with the UE to terminate the communication session; and
controlling the reflection properties of the RIS to no longer reflect the wireless signals as transmitted and/or received by the UE upon having exchanged the further signalling.

36. A method for maintaining a communication session between a user equipment (UE) and a controller entity of a reconfigurable intelligent surface (RIS), wherein the method is performed by the UE and wherein the method comprises:
sending a request signal towards the controller entity to activate the RIS for wireless signals as transmitted and/or received by the UE to be reflected by the RIS;
receiving a response signal from the controller entity that the RIS has been activated for reflection of the wireless signals, wherein the response signal is indicative of that the communication session has been established between the UE and the controller entity; and
repeatedly providing signalling towards the controller entity indicative of that the communication session is to be maintained whilst performing a multipath wireless communication comprising transmitting and/or receiving the wireless signals.

37. The method of claim 36, comprising repeatedly providing the signalling towards the controller entity as long as the multipath wireless communication is ongoing.

38. The method of claim 36, wherein the signalling either is identical to the request signal or is a tracking signal.

39. The method of claim 36, wherein performing the multipath wireless communication comprises directing at least a first path of the multipath wireless communication for transmission and/or reception of the wireless signals to be reflected by the RIS and directing at least a second path of the multipath wireless communication for transmission and/or reception of the wireless signals to not be reflected by the RIS, the method further comprising:
exchanging further signalling with the controller entity to terminate the communication session; and
terminating at least the first path of the multipath wireless communication upon having exchanged the further signalling.
